(19) United States
(12) Patent Application Publication
(10) Pub. No.: US 2017/0034685 A1
(43) Pub. Date: Feb. 2, 2017

(54) LTE-D2D DISCOVERY IN THE UNLICENSED BAND

(71) Applicant: QUALCOMM Incorporated, San Diego, CA (US)

(72) Inventors: Libin Jiang, Bridgewater, NJ (US); Wei Guan, Bridgewater, NJ (US); Shailesh Patil, Raritan, NJ (US)

(21) Appl. No.: 15/194,428

(22) Filed: Jun. 27, 2016

Related U.S. Application Data
(60) Provisional application No. 62/197,434, filed on Jul. 27, 2015.

(51) Int. Cl. H04W 8/00; H04W 74/08; H04L 27/26; H04W 76/02; H04W 72/04

(52) U.S. Cl. CPC H04W 8/005; H04W 76/023; H04W 72/0446; H04W 72/0453; H04L 27/2601; H04W 74/0816

(57) ABSTRACT

Described herein are methods, systems, and apparatus for performing device-to-device (D2D) discovery in an unlicensed band. In one example, a method for wireless communication is described that includes identifying a resource pool for D2D discovery in an unlicensed radio frequency spectrum band and selecting a set of resource blocks in the identified resource pool. The method may also include performing a channel occupancy check for the channel in the selected set of resource blocks. The method further includes transmitting a D2D discovery message based at least in part on the channel occupancy check, the D2D discovery message transmitted over the selected set of resource blocks in the unlicensed radio frequency spectrum band.

### CROSS REFERENCES

The present application for patent claims priority to U.S. Provisional Patent Application No. 62/197,434 by Jiang, et al., entitled “LTE-D2D DISCOVERY IN THE UNLICENSED BAND,” filed Jul. 27, 2015, assigned to the assignee hereof.

### BACKGROUND

Field of the Disclosure

The present disclosure, for example, relates to wireless communication systems, and more particularly to discovery transmissions in an unlicensed band.

Description of Related Art

Wireless communication systems are widely deployed to provide various types of communication content such as voice, video, packet data, messaging, broadcast, and so on. These systems may be multiple-access systems capable of supporting communication with multiple users by sharing the available system resources (e.g., time, frequency, and power). Examples of such multiple-access systems include code-division multiple access (CDMA) systems, time-division multiple access (TDMA) systems, frequency-division multiple access (FDMA) systems, and orthogonal frequency-division multiple access (OFDMA) systems.

By way of example, a wireless multiple-access communication system may include a number of base stations, each simultaneously supporting communication for multiple communication devices, otherwise known as user equipments (UEs). A base station may communicate with UEs on downlink channels (e.g., for transmissions from a base station to a UE) and uplink channels (e.g., for transmissions from a UE to a base station).

In a Long-Term Evolution (LTE) network, procedures for device-to-device (D2D) discovery in the licensed band were standardized in Release 12. In LTE-D discovery, the network reserves resource pools for discovery and periodically creates these pools. Each resource pool consists of a number of time-frequency resources. A participating UE may broadcast its discovery message in a randomly chosen time-frequency resource. The randomization may allow in-band emissions diversity so that more UEs can be discovered over time.

There may be different regulations for D2D transmissions on an unlicensed spectrum space than there are on the licensed spectrum space. One regulatory requirement may be that transmissions should occupy at least some amount of bandwidth. Another requirement may be that a device must listen before talk (LBT) to determine a channel is clear before transmitting signals over the channel.

### SUMMARY

Techniques, systems, and devices are described herein for doing device-to-device (D2D) discovery on an unlicensed LTE spectrum. The LTE network may periodically reserve resource pools for discovery. Resource pools include time-frequency resources that may be divided into a number of equal-sized time-frequency resources referred to as DRIDs. A UE may select a number of DRIDs that do not overlap in time that the UE may use to gain access to the unlicensed band. The UE may try to transmit a discovery message on the earliest chosen DRID. Before transmission, the UE may perform a clear channel check. If the channel is busy, the UE may try to transmit the discovery message on the next in time DRID. If the channel is idle for a time, the UE may transmit the discovery message after waiting a short time.

In a first set of illustrative examples, a method for wireless communication is described. In one configuration, the method includes identifying a resource pool for D2D discovery in an unlicensed radio frequency spectrum band and selecting a set of resource blocks in the identified resource pool. The method may also include performing a channel occupancy check for a channel in the selected set of resource blocks and transmitting a D2D discovery message based at least in part on the channel occupancy check, the D2D discovery message transmitted over the selected set of resource blocks in the unlicensed radio frequency spectrum band.

In a second set of illustrative examples, an apparatus for wireless communication is described. In one configuration, the apparatus may include means for identifying a resource pool for D2D discovery in an unlicensed radio frequency spectrum band and means for selecting a set of resource blocks in the identified resource pool. The apparatus may also include means for performing a channel occupancy check for a channel in the selected set of resource blocks and means for transmitting a D2D discovery message based at least in part on the channel occupancy check, the D2D discovery message transmitted over the selected set of resource blocks in the unlicensed radio frequency spectrum band.

In a third set of illustrative examples, another apparatus for wireless communication is described. In one configuration, the apparatus may include a processor, memory in electronic communication with the processor, and instructions stored in the memory. The instructions may be executable by the processor to identify a resource pool for D2D discovery in an unlicensed radio frequency spectrum band and select a set of resource blocks in the identified resource pool. The instructions may be further executable by the processor to perform a channel occupancy check for a channel in the selected set of resource blocks and transmit a D2D discovery message based at least in part on the channel occupancy check, the D2D discovery message transmitted over the selected set of resource blocks in the unlicensed radio frequency spectrum band.

In a fourth set of illustrative examples, a non-transitory computer-readable medium storing computer-executable code for wireless communication is described. In one configuration, the computer-executable code may be executable by a processor to identify a resource pool for D2D discovery in an unlicensed radio frequency spectrum band and select a set of resource blocks in an identified resource pool. The computer-executable code may be executable by a processor to perform a channel occupancy check for a channel in the selected set of resource blocks and transmit a D2D discovery message based at least in part on the channel occupancy check, the D2D discovery message transmitted over the selected set of resource blocks in the unlicensed radio frequency spectrum band.

Some examples of the methods, apparatuses, and non-transitory computer-readable mediums include identifying a transmission bandwidth requirement for the channel and selecting the set of resource blocks in the resource pool based at least in part on the identified transmission bandwidth requirement.

In some examples of the methods, apparatuses, and non-transitory computer-readable mediums, performing the channel occupancy check further includes performing a listen-before-talk procedure for the channel in the selected set of resource blocks. In other examples, performing the channel occupancy check further includes listening to the channel for a first time period to determine whether the channel is idle and waiting for a second time period after the first time period to transmit the D2D discovery message upon determining the channel is idle.

Some examples of the methods, apparatuses, and non-transitory computer-readable mediums include selecting the first time period and the second time period to perform the channel occupancy check to be a duration corresponding to a duration of two orthogonal frequency-division multiplexing (OFDM) symbols. Another example includes selecting one or more time-frequency resources from the identified resource pool, the time-frequency resources comprising at least the selected set of resource blocks. The selected time-frequency resources may cover different time periods.

In some examples of the methods, apparatuses, and non-transitory computer-readable mediums, transmitting the D2D discovery message further includes transmitting the D2D discovery message using a first time-frequency resource based on the channel occupancy check, the first time-frequency resource comprising at least a portion of the selected set of resource blocks. Performing the channel occupancy check may further include listening to the channel for a first time period to determine whether the channel is occupied for at least a portion of the selected first time-frequency resource and upon determining the channel is occupied, listening to the channel for the first time period to determine whether the channel is idle for a second time-frequency resource, wherein the second time-frequency resource occurs after the first time-frequency resource.

Some examples of the methods, apparatuses, and non-transitory computer-readable mediums include refraining from transmitting the D2D discovery message based at least in part on the channel occupancy check and listening for D2D discovery messages from other wireless devices during at least a portion of the selected set of resource blocks.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purpose of illustration and description only, and not as a definition of the limits of the claims.

### BRIEF DESCRIPTION OF THE DRAWINGS

A further understanding of the nature and advantages of the present invention may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 shows a diagram of a wireless communication system, in accordance with various aspects of the present disclosure;

FIG. 2 shows a diagram of a wireless communication system, in accordance with various aspects of the present disclosure;

FIG. 3 shows a flow diagram illustrating example D2D process in an unlicensed band of a wireless communication system, in accordance with various aspects of the present disclosure;

FIG. 4 shows a diagram of resource pools and DRIDs, in accordance with various aspects of the present disclosure;

FIG. 5 shows a block diagram of a device configured for use in wireless communication, in accordance with various aspects of the present disclosure;

FIG. 6 shows a block diagram of a device configured for use in wireless communication, in accordance with various aspects of the present disclosure;

FIG. 7 shows a block diagram of a wireless communication system, in accordance with various aspects of the present disclosure;

FIG. 8 shows a block diagram of an apparatus for use in wireless communication, in accordance with various aspects of the present disclosure;

FIG. 9 shows a block diagram of an apparatus for use in wireless communication, in accordance with various aspects of the present disclosure;

FIG. 10 shows a block diagram of a base station (e.g., a base station forming part or all of an eNB) for use in wireless communication, in accordance with various aspects of the present disclosure;

FIG. 11 is a flow chart illustrating an example of a method for wireless communication, in accordance with various aspects of the present disclosure; and

FIG. 12 is a flow chart illustrating an example of a method for wireless communication, in accordance with various aspects of the present disclosure.

### DETAILED DESCRIPTION

For device-to-device (D2D) discovery in a network, the network may reserve resource pools for discovery purposes. These resource pools may occur periodically and include a number of resource blocks that are configured into DRIDs. A UE may choose one or more DRIDs for D2D discovery transmissions. The UE may attempt to transmit the D2D discovery message on an unlicensed band using the DRID that occurs first in time.

An unlicensed band may have regulations that are required to be met for transmission on the band. For D2D discovery between UEs, a UE may have to meet the regulations for transmission of D2D discovery messages. Such regulations may include a minimum bandwidth requirement and a “listen before talk” (LBT) requirement. To meet the minimum bandwidth requirement, the UE may transmit over several resource blocks that add up to the required amount of bandwidth. For the LBT requirement, the UE may listen to the channel to determine if the channel is idle before transmitting the D2D discovery message.

The following description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in other examples.

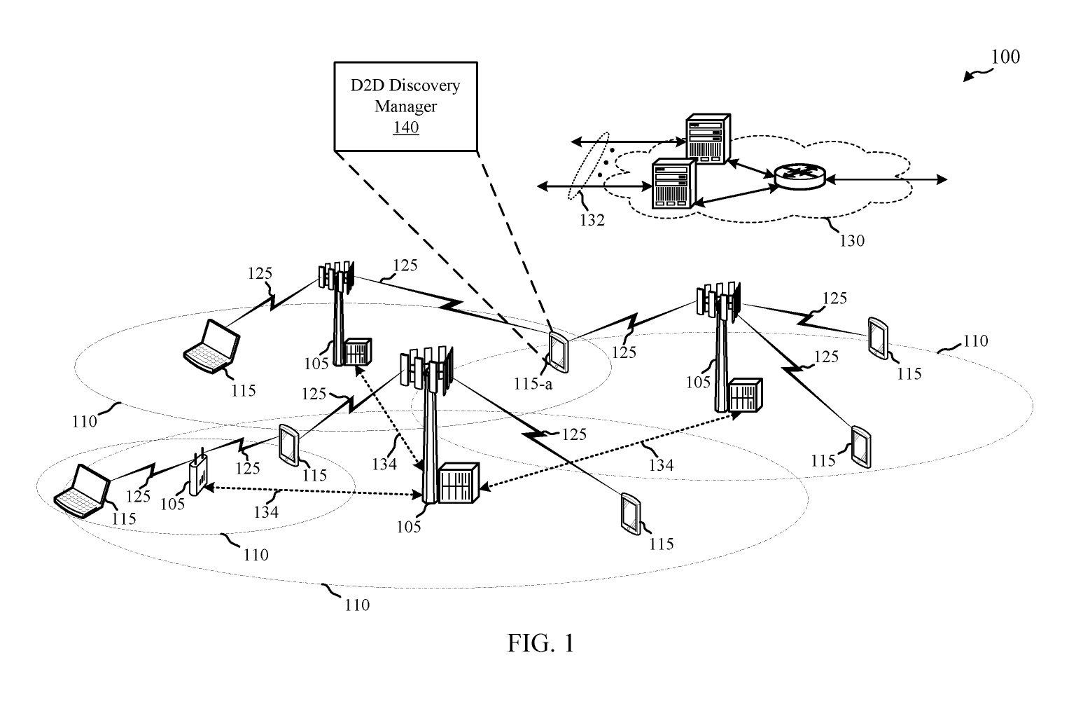

FIG. 1 illustrates an example of a wireless communications system 100 in accordance with various aspects of the disclosure. The wireless communications system 100 includes base stations 105, UEs 115, and a core network 130. The core network 130 may provide user authentication, access authorization, tracking, Internet Protocol (IP) connectivity, and other access, routing, or mobility functions. The base stations 105 interface with the core network 130 through backhaul links 132 (e.g., S1, etc.) and may perform radio configuration and scheduling for communication with the UEs 115, or may operate under the control of a base station controller. In various examples, the base stations 105 may communicate, either directly or indirectly (e.g., through core network 130), with each other over backhaul links 134 (e.g., X1, etc.), which may be wired or wireless communication links.

The base stations 105 may wirelessly communicate with the UEs 115 via one or more base station antennas. Each of the base station 105 sites may provide communication coverage for a respective geographic coverage area 110. In some examples, base stations 105 may be referred to as a base transceiver station, a radio base station, an access point, a radio transceiver, a NodeB, eNodeB (eNB), Home NodeB, a Home eNodeB, or some other suitable terminology. The geographic coverage area 110 for a base station 105 may be divided into sectors making up only a portion of the coverage area. The wireless communications system 100 may include base stations 105 of different types (e.g., macro and/or small cell base stations). There may be overlapping geographic coverage areas 110 for different technologies.

In some examples, the wireless communications system 100 is an LTE/LTE-A network. In LTE/LTE-A networks, the term evolved Node B (eNB) may be generally used to describe the base stations 105, while the term UE may be generally used to describe the UEs 115. The wireless communications system 100 may be a Heterogeneous LTE/LTE-A network in which different types of eNBs provide coverage for various geographical regions. For example, each eNB or base station 105 may provide communication coverage for a macro cell, a small cell, and/or other types of cell. The term “cell” is a 3GPP term that can be used to describe a base station, a carrier or component carrier associated with a base station, or a coverage area (e.g., sector, etc.) of a carrier or base station, depending on context.

A macro cell generally covers a relatively large geographic area (e.g., several kilometers in radius) and may allow unrestricted access by UEs with service subscriptions with the network provider. A small cell is a lower-powered base station, as compared with a macro cell, that may operate in the same or different (e.g., licensed, unlicensed, etc.) frequency bands as macro cells. Small cells may include pico cells, femto cells, and micro cells according to various examples. A pico cell may cover a relatively smaller geographic area and may allow unrestricted access by UEs with service subscriptions with the network provider. A femto cell also may cover a relatively small geographic area (e.g., a home) and may provide restricted access by UEs having an association with the femto cell (e.g., UEs in a closed subscriber group (CSG), UEs for users in the home, and the like). An eNB for a macro cell may be referred to as a macro eNB. An eNB for a small cell may be referred to as a small cell eNB, a pico eNB, a femto eNB or a home eNB. An eNB may support one or multiple (e.g., two, three, four, and the like) cells (e.g., component carriers).

The wireless communications system 100 may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. The techniques described herein may be used for either synchronous or asynchronous operations.

The communication networks that may accommodate some of the various disclosed examples may be packet-based networks that operate according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use Hybrid ARQ (HARQ) to provide retransmission at the MAC layer to improve link efficiency. In the control plane, the Radio Resource Control (RRC) protocol layer may provide establishment, configuration, and maintenance of an RRC connection between a UE 115 and the base stations 105 or core network 130 supporting radio bearers for the user plane data. At the Physical (PHY) layer, the transport channels may be mapped to Physical channels.

The UEs 115 are dispersed throughout the wireless communications system 100, and each UE 115 may be stationary or mobile. A UE 115 may also include or be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. A UE 115 may be a cellular phone, a personal digital assistant (PDA), a wireless modem, a wireless communication device, a handheld device, a tablet computer, a laptop computer, a cordless phone, a wireless local loop (WLL) station, or the like. A UE may be able to communicate with various types of base stations and network equipment including macro eNBs, small cell eNBs, relay base stations, and the like.

The communication links 125 shown in wireless communications system 100 may include uplink (UL) transmissions from a UE 115 to a base station 105, and/or downlink (DL) transmissions, from a base station 105 to a UE 115. The downlink transmissions may also be called forward link transmissions while the uplink transmissions may also be called reverse link transmissions. Each communication link 125 may include one or more carriers, where each carrier may be a signal made up of multiple sub-carriers (e.g., waveform signals of different frequencies) modulated according to the various radio technologies described above. Each modulated signal may be sent on a different sub-carrier and may carry control information (e.g., reference signals, control channels, etc.), overhead information, user data, etc. The communication links 125 may transmit bidirectional communications using frequency division duplexing (FDD) (e.g., using paired spectrum resources) or time division duplexing (TDD) operation (e.g., using unpaired spectrum resources). Frame structures for FDD (e.g., frame structure type 1) and TDD (e.g., frame structure type 2) may be defined.

In some embodiments of the wireless communications system 100, base stations 105 and/or UEs 115 may include multiple antennas for employing antenna diversity schemes to improve communication quality and reliability between base stations 105 and UEs 115. Additionally or alternatively, base stations 105 and/or UEs 115 may employ multiple-input, multiple-output (MIMO) techniques that may take advantage of multi-path environments to transmit multiple spatial layers carrying the same or different coded data.

Wireless communications system 100 may support operation on multiple cells or carriers, a feature which may be referred to as carrier aggregation (CA) or multi-carrier operation. A carrier may also be referred to as a component carrier (CC), a layer, a channel, etc. The terms “carrier,” “component carrier,” “cell,” and “channel” may be used interchangeably herein. A UE 115 may be configured with multiple downlink CCs and one or more uplink CCs for carrier aggregation. Carrier aggregation may be used with both FDD and TDD component carriers.

A UE 115, such as a UE 115-a, may include a D2D discovery manager 140. The D2D discovery manager 140 may perform D2D discovery in an unlicensed band. Functions the D2D discovery manager 140 may perform include identifying a resource pool for D2D discovery in an unlicensed radio frequency spectrum band and selecting a set of resource blocks in the identified resource pool. The D2D discovery manager 140 may also perform a channel occupancy check for the channel in the selected set of resource blocks and transmitting a D2D discovery message based at least in part on the channel occupancy check, the D2D discovery message transmitted over the selected set of resource blocks in the unlicensed radio frequency spectrum band.

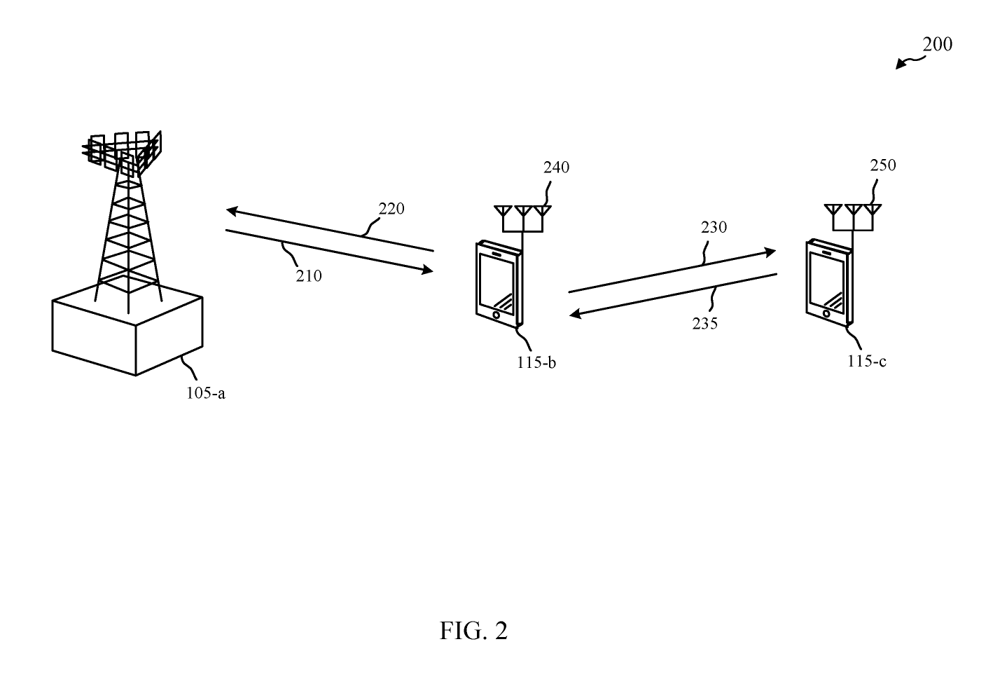

FIG. 2 shows a diagram of a wireless communications system 200, in accordance with various aspects of the present disclosure. The wireless communications system 200 may include a UE 115-b, a UE 115-c, and BS 105-b, which may be examples of a UE 115 and base station 105 described with reference to FIG. 1. The BS 105-a may communicate with the UE 115-b over a downlink channel 210 and the UE 115-b may communicate with the BS 105-a over an uplink channel 220. The UE 115-b may have multiple antennas 240 for multiple radio access technologies (RATs). Likewise, the UE 115-c may have multiple antennas 250 for multiple RATs.

Before the UE 115-b performs D2D discovery, the BS 105-a may reserve resource pools for discovery in an unlicensed radio frequency spectrum band. The UE 115-b, which may be within a cell of the BS 105-a, may identify a resource pool for D2D discovery. The UE 115-b may select a set of resource blocks in the identified resource pool. The selection may be random.

If the UE 115-b has clearance to transmit a discovery message (e.g., the unlicensed channel is idle), the UE 115-b may transmit a discovery message 230 over the selected set of resource blocks in the unlicensed radio frequency spectrum band. The UE 115-c may receive the discovery message 230. In some examples, the UE 115-c may transmit a discovery message 235 that the UE 115-b may receive.

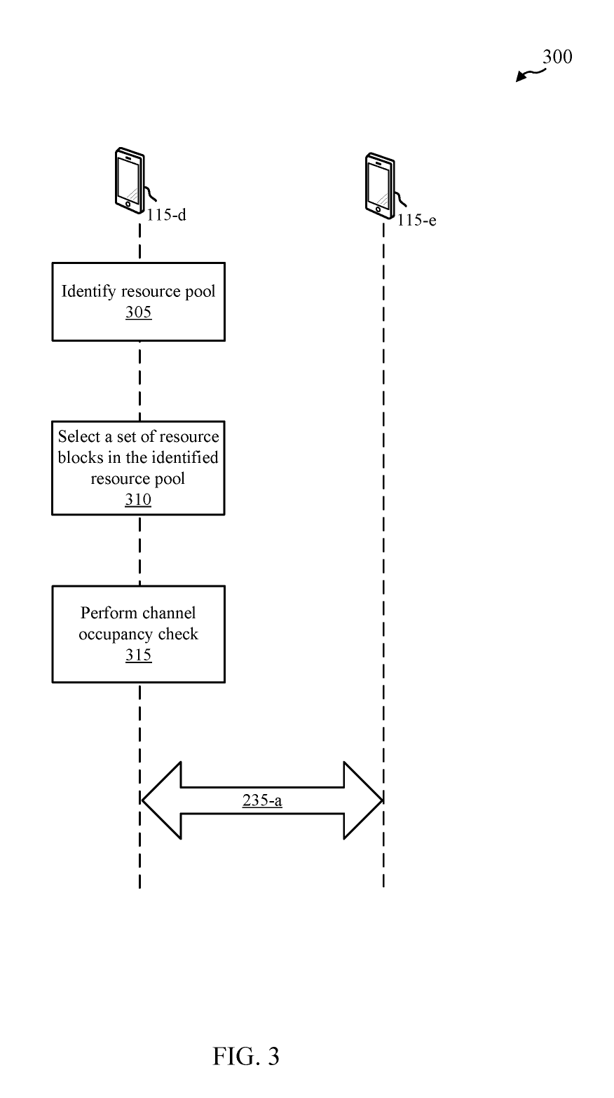

FIG. 3 shows a flow diagram illustrating example process 300 of D2D discovery in an unlicensed band of a wireless communication system, in accordance with various aspects of the present disclosure. The process 300 includes a UE 115-d and a UE 115-e. The UEs 115-d and 115-e may be an example of aspects of the UEs 115 of FIGS. 1 and 2.

In the example of FIG. 3, the UE 115-d is performing D2D discovery in an unlicensed LTE band. The UE 115-d identifies a resource pool on the network (305). The UE 115-d may select a set of resource blocks in the identified resource pool (310). In selecting the resource blocks, the UE 115-d may be selecting one or more DRIDs. In each resource pool (i.e., each discovery period), the UE 115-d chooses m, wherein m≧1 DRIDs which do not overlap in time. In some examples, the choice is random. In other examples, the choice is based on an algorithm. In some examples, m is between 5 and 10, inclusive.

The UE 115-b may try to transmit its discovery message on a DRID that is the earliest in time of the chosen DRIDs. However, before transmitting, the UE 115-b may perform a channel occupancy check (e.g., a clear channel scan) to determine if an unlicensed channel is idle (315). The UE 115-b may listen to the channel for a first amount of time. The first amount of time may be referred to as a csTime. If the channel is idle during csTime, then after an RxTxTurnaround time, the UE transmits the discovery message 235-a in the remaining time of the DRID. If the channel is busy at any time of the csTime duration, the UE 115-d does not transmit on the DRID and instead will try to transmit in the next chosen DRID. The attempts continue until the UE has managed to transmit in the period or all the chosen DRIDs have been tried.

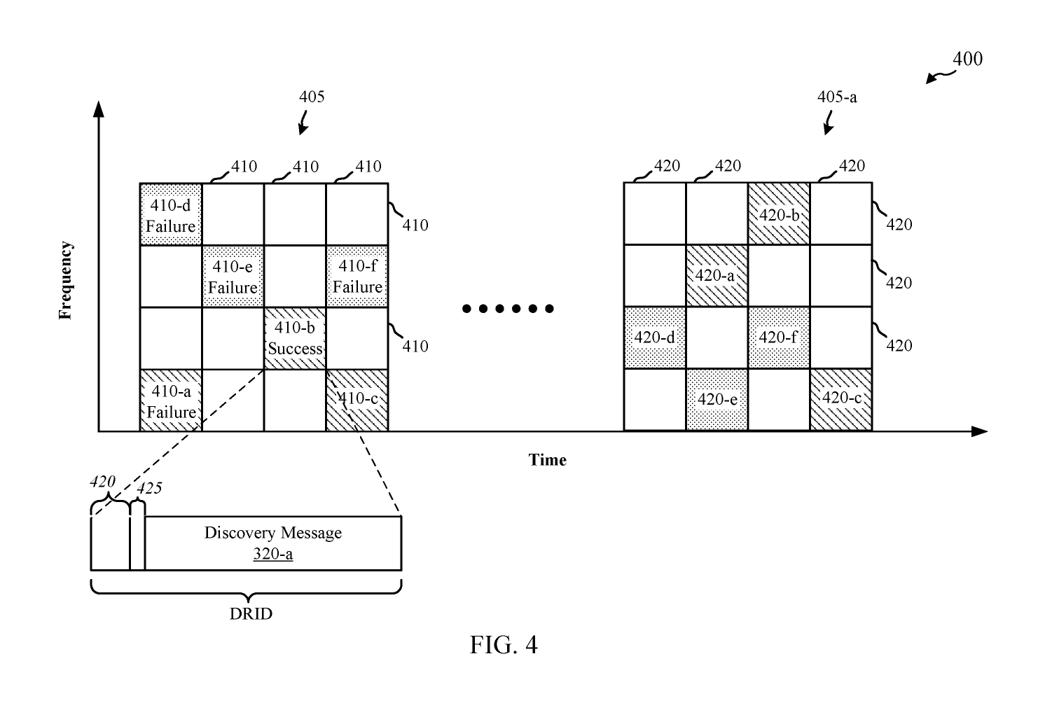

FIG. 4 shows a diagram 400 of resource pools and DRIDs, in accordance with various aspects of the present disclosure. FIG. 4 illustrates a first-in-time resource pool 405 and a second-in-time resource pool 405-a. The network may reserve additional resource pools between the first-in-time resource pool 405 and the second-in-time resource pool 405-a.

Resource pools may be periodically reserved for LTE-D discovery. The resources may be pre-configured or fixed in a specification with respect to global time. In another example, the resources can be configured by the network on the licensed spectrum. Each resource pool is divided into a number of equal-sized time-frequency resources (called “DRIDs”). The first-in-time resource pool 405 may be broken down into a number of DRIDs 410, although for clarity only some of the DRIDs 410 are labeled in FIG. 4. In some examples, the DRIDs 410 may be equal-sized in terms of time-frequency resources. In other examples, the DRIDs 410 may have differing sizes.

One DRID 410 may occupy a number of consecutive resource blocks (RBs) in a number of consecutive subframes (e.g., 3 consecutive RBs in one subframe). The number of RBs may be chosen (e.g., by the network or BS) to meet the minimum bandwidth requirement of the unlicensed band.

In FIG. 4, a first UE, such as the UE 115-c of FIG. 3, has selected three DRIDs 410-a through 410-c for transmission attempts. The second UE, such as the UE 115-d of FIG. 3, has also selected three DRIDs 410-d through 410-f for transmission attempts. Each of the UEs will try to transmit their discovery messages on their earliest chosen DRID. Whenever a UE does not transmit in a discovery resource pool, it will try to receive the discovery messages transmitted by other UEs.

The first UE tries to transmit its discovery message on the earliest chosen DRID, which is the DRID 410-a in this example. From the starting time of the DRID 410-a, the first UE listens to the channel for csTime 420 amount of time. If the channel is idle during csTime 420, then after an RxTxTurnaround 425 time, the first UE transmits the discovery message in the remaining time of the DRID. If the channel is busy at any time of the csTime 420 duration, the first UE does not transmit on the DRID, and will try to transmit in the next chosen DRID 410-b. The attempts continue until the first UE has managed to transmit in the period or all the chosen DRIDs have been tried.

In the example of FIG. 4, the first UE listens to the channel for csTime 420 for the DRID 410-a. Finding the channel occupied, the first UE does not transmit the discovery message during the DRID 410-a and instead regards the DRID 410-a as a failure. Next, the first UE listens to the channel for the DRID 410-b for csTime 420. Finding the channel idle during csTime 420, the first UE waits to transmit the discovery message after the RxTxTurnaround 425. Once the first UE transmits its discovery message, the first UE may not attempt to transmit on the third DRID 410-c.

In some examples, the time parameters csTime 420 and RxTxTurnaround 425 may be chosen such that they add up to be two OFDM symbols. In an example where each DRID 410 occupies one subframe (e.g., 14 OFDM symbols), then the discovery message can occupy the remaining 12 OFDM symbols.

The second UE attempts to transmit its discovery message similarly to the first UE. Finding the channel occupied during the DRID 410-d, the second UE proceeds to the DRID 410-e. In this example, the second UE also finds the channel occupied during the DRID 410-e. Again, the second UE finds the channel occupied during the DRID 410-f.

The process may repeat for the next resource pool, such as the second-in-time resource pool 405-a. For example, the first UE may select DRIDs 410-a, 410-b, and 410-c and the second UE may select DRIDs 410-d, 410-e, and 410-f. The process for gaining access to the channel may proceed similarly as described above for the first-in-time resource pool 405.

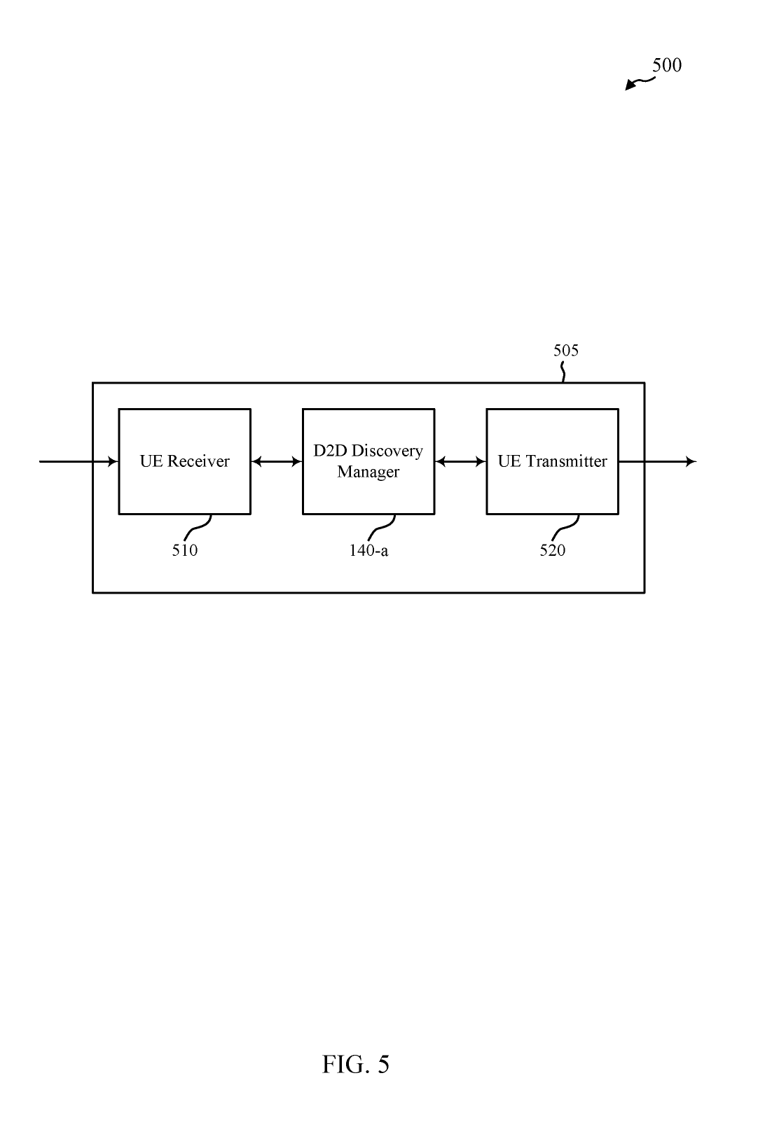

FIG. 5 shows a block diagram 500 of a device 505 for use in wireless communication, in accordance with various aspects of the present disclosure. The device 505 may be an example of one or more aspects of a UE 115 described with reference to FIGS. 1-3. The device 505 may include a UE receiver 510, a D2D discovery manager 140-a, and/or a UE transmitter 520. The device 505 may also be or include a processor. Each of these modules may be in communication with each other.

The components of the device 505 may, individually or collectively, be implemented using one or more application-specific integrated circuits (ASICs) adapted to perform some or all of the applicable functions in hardware. Alternatively, the functions may be performed by one or more other processing units (or cores), on one or more integrated circuits. In other examples, other types of integrated circuits may be used (e.g., Structured/Platform ASICs, Field Programmable Gate Arrays (FPGAs), and other Semi-Custom ICs), which may be programmed in any manner known in the art. The functions of each module may also be implemented, in whole or in part, with instructions embodied in a memory, formatted to be executed by one or more general or application-specific processors.

The UE receiver 510 may receive information such as packets, user data, and/or control information associated with various information channels (e.g., control channels, data channels, etc.). The UE receiver 510 may be configured to receive discovery messages and information regarding reserved resource pools. Information may be passed on to the D2D discovery manager 140-a, and to other components of the device 505. The UE receiver 510 may listen to a channel for channel occupancy.

The D2D discovery manager 140-a manages discovery message transmissions on an unlicensed LTE band. The D2D discovery manager 140-a identifies a resource pool for D2D discovery in an unlicensed radio frequency spectrum band. The D2D discovery manager 140-a may also select a set of resource blocks in the identified resource pool. The D2D discovery manager 140-a may perform a channel occupancy check for the channel in the selected set of resource blocks using the UE receiver 510.

The UE transmitter 520 may transmit the one or more signals received from other components of the device 505. The UE transmitter 520 may transmit a D2D discovery message based at least in part on the channel occupancy check, the D2D discovery message transmitted over the selected set of resource blocks in the unlicensed radio frequency spectrum band. In some examples, the UE transmitter 520 may be collocated with the UE receiver 510 in a transceiver module.

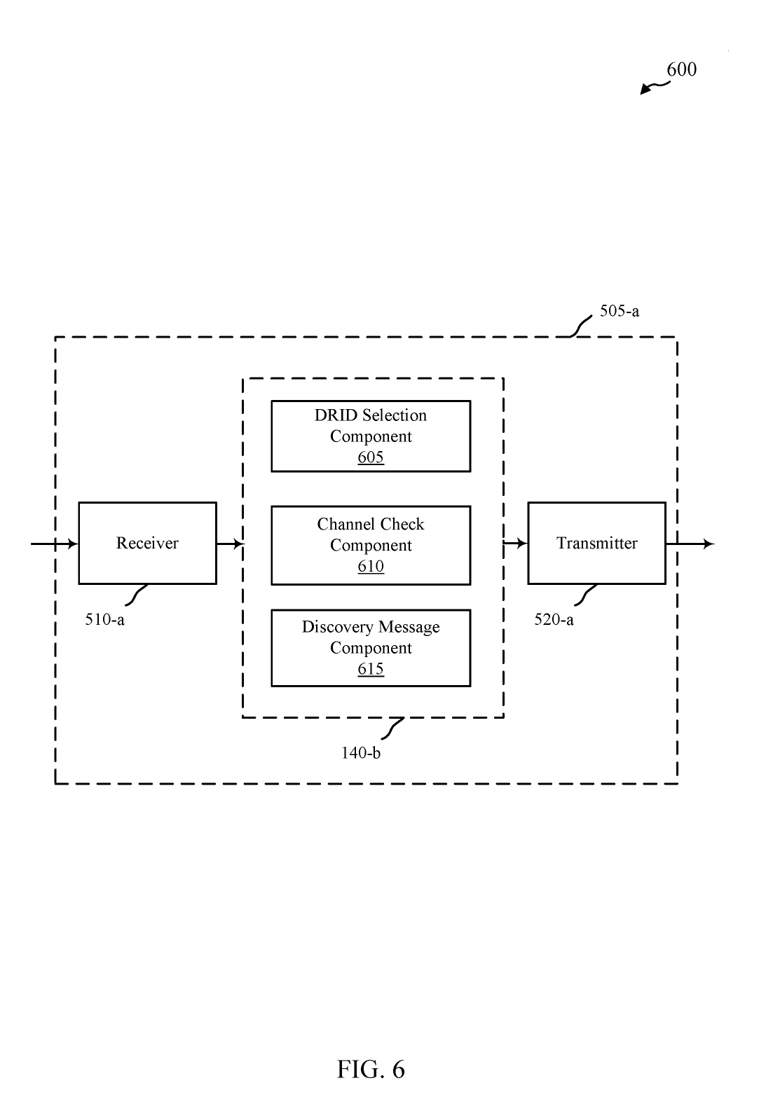

FIG. 6 shows a block diagram 600 of a device 505-a for use in wireless communication, in accordance with various examples. The device 505-a may be an example of one or more aspects of a UE 115 described with reference to FIGS. 1-3. It may also be an example of a device 505 described with reference to FIG. 5. The device 505-a may include a UE receiver 510-a, a D2D discovery manager 140-b, and/or a UE transmitter 520-a, which may be examples of the corresponding modules of device 505. The device 505-a may also include a processor. Each of these components may be in communication with each other. The D2D discovery manager 140-b may include a DRID selection component 605, a channel check component 610, and a discovery message component 615. The UE receiver 510-a and the UE transmitter 520-a may perform the functions of the UE receiver 510 and the UE transmitter 520, of FIG. 5, respectively.

The DRID selection component 605 may select one or more DRIDs for potential D2D discovery message transmissions. The DRID selection component 605 may identifying one or more resource pools for D2D discovery in an unlicensed radio frequency spectrum band. The DRID selection component 605 may select a set of resource blocks in the identified resource pool. In some examples, the DRID selection component 605 randomly selects the resource blocks. The DRID selection component 605 may select time-frequency resources that cover different time periods (e.g., the DRIDs do not overlap in time).

In some examples, the DRID selection component 605 identifies a transmission bandwidth requirement for the channel. The DRID selection component 605 selects the set of resource blocks in the resource pool based at least in part on the identified transmission bandwidth requirement. The DRID selection component 605 selects one or more time-frequency resources from the identified resource pool, the time-frequency resources comprising at least the selected set of resource blocks.

The channel check component 610 may performing a channel occupancy check for the channel in the selected set of resource blocks. In some examples, performing the channel occupancy check includes performing a LBT procedure for the channel in the selected set of resource blocks. This may include listening to the channel for a first time period (e.g., csTime) to determine whether the channel is idle and waiting for a second time period (e.g., RxTxTurnaround) after the first time period to transmit the D2D discovery message upon determining the channel is idle. The channel check component 610 may select a first time period and a second time period to perform the channel occupancy check to be a duration corresponding to a duration of two OFDM symbols.

When the channel check component 610 determines that the channel is occupied during a first time period of the first DRID, the channel check component 610 may listen to the channel for the first time period to determine whether the channel is idle for a second time-frequency resource, wherein the second time-frequency resource occurs after the first time-frequency resource.

The discovery message component 615 cause a D2D discovery message to be transmitted based at least in part on the channel occupancy check, the D2D discovery message transmitted over the selected set of resource blocks in the unlicensed radio frequency spectrum band. In some examples, transmitting the D2D discovery message using a first time-frequency resource is based on the channel occupancy check, the first time-frequency resource comprising at least a portion of the selected set of resource blocks. The discovery message component 615 may refrain from transmitting the D2D discovery message based at least in part on the channel occupancy check.

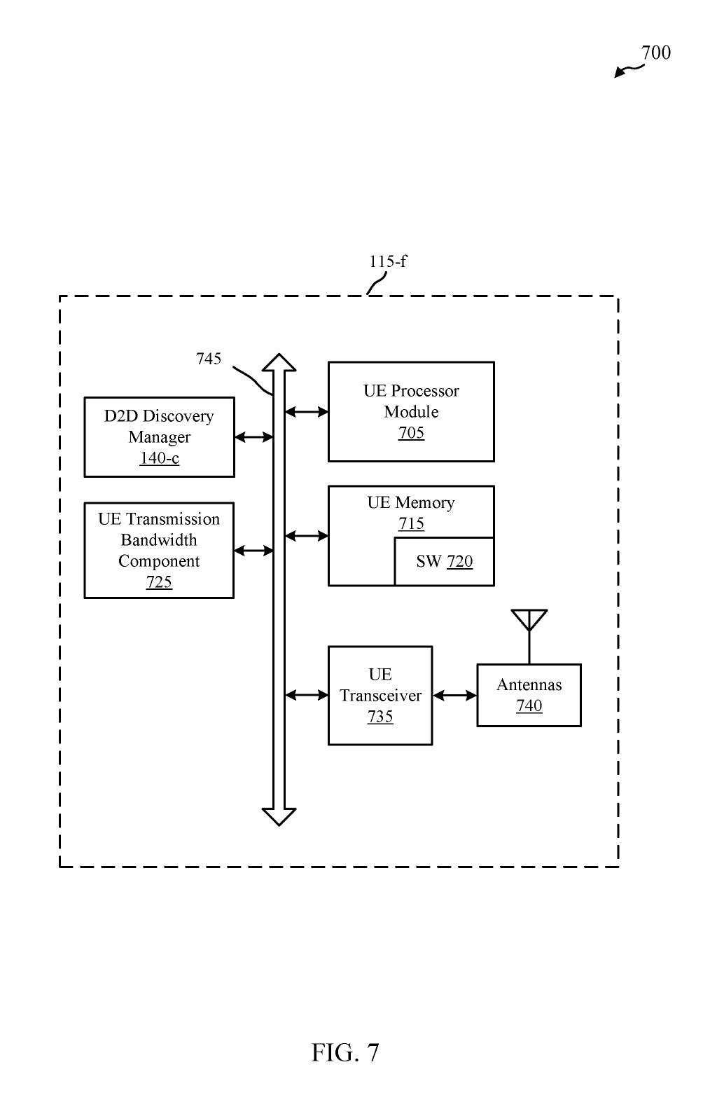

FIG. 7 shows a system 700 for use in wireless communication, in accordance with various examples. The system 700 may include a UE 115-f, which may be an example of the UEs 115 of FIGS. 1-3. UE 115-f may also be an example of one or more aspects of devices 505 of FIGS. 5 and 6.

The UE 115-f may generally include components for bi-directional voice and data communications including components for transmitting communications and components for receiving communications. The UE 115-f may include antenna(s) 740, a UE transceiver 735, a UE processor module 705, and memory 715 (including software (SW) 720), which each may communicate, directly or indirectly, with each other (e.g., via one or more buses 745). The UE transceiver 735 may be configured to communicate bi-directionally, via the antenna(s) 740 and/or one or more wired or wireless links, with one or more networks, as described above. For example, the UE transceiver 735 may be configured to communicate bi-directionally with base stations 105 with reference to FIG. 1. The UE transceiver 735 may include a modem configured to modulate the packets and provide the modulated packets to the antenna(s) 740 for transmission, and to demodulate packets received from the antenna(s) 740. While the UE 115-f may include a single antenna 740, the UE 115-f may have multiple antennas 740 capable of concurrently transmitting and/or receiving multiple wireless transmissions. The UE transceiver 735 may be capable of concurrently communicating with one or more base stations 105 via multiple component carriers.

The UE 115-f may include a D2D discovery manager 140-c, which may perform the functions described above for the D2D discovery manager 140 of FIGS. 1, 5, and 6. The UE 115-f may also include a UE transmission bandwidth component 725. The UE transmission bandwidth component 725 may identify a transmission bandwidth requirement for the channel. The UE 115-f may use transmission bandwidth requirement to select the set of resource blocks or DRIDs.

The memory 715 may include random access memory (RAM) and read-only memory (ROM). The memory 715 may store computer-readable, computer-executable software/firmware code 720 containing instructions that are configured to, when executed, cause the UE processor module 705 to perform various functions described herein (e.g., D2D discovery in an unlicensed band, etc.). Alternatively, the computer-readable, computer-executable software/firmware code 720 may not be directly executable by the UE processor module 705 but be configured to cause a computer (e.g., when compiled and executed) to perform functions described herein. The UE processor module 705 may include an intelligent hardware device, e.g., a central processing unit (CPU), a microcontroller, an application-specific integrated circuit (ASIC), etc.

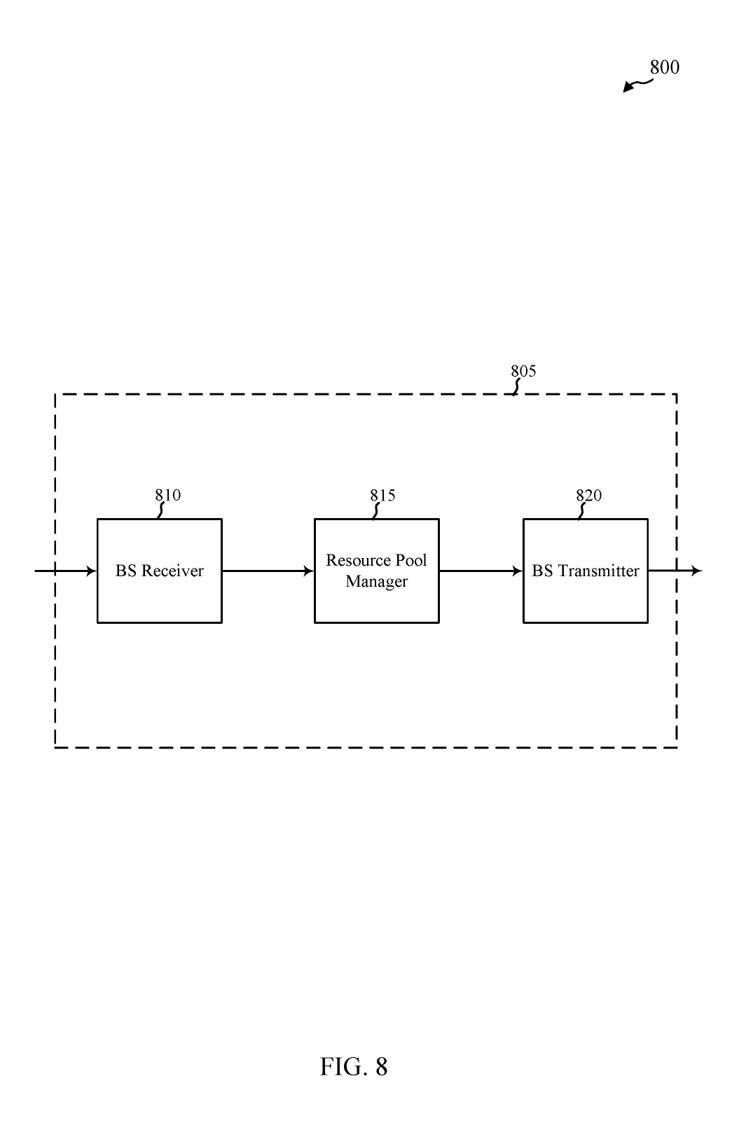

FIG. 8 shows a block diagram 800 of an apparatus 805 for use in wireless communication, in accordance with various aspects of the present disclosure. In some examples, the apparatus 805 may be an example of aspects of one or more of the base stations 105 described with reference to FIG. 1. In some examples, the apparatus 805 may be part or include an LTE/LTE-A eNB and/or an LTE/LTE-A base station. The apparatus 805 may also be a processor. The apparatus 805 may include a BS receiver 810, a resource pool manager 815, and/or a BS transmitter 820. Each of these modules may be in communication with each other.

The components of the apparatus 805 may, individually or collectively, be implemented using one or more ASICs adapted to perform some or all of the applicable functions in hardware. Alternatively, the functions may be performed by one or more other processing units (or cores), on one or more integrated circuits. In other examples, other types of integrated circuits may be used (e.g., Structured/Platform ASICs, FPGAs, and other Semi-Custom ICs), which may be programmed in any manner known in the art. The functions of each component may also be implemented, in whole or in part, with instructions embodied in a memory, formatted to be executed by one or more general or application-specific processors.

In some examples, the BS receiver 810 may include at least one radio frequency (RF) receiver, such as an RF receiver operable to receive D2D discovery messages. The BS receiver 810 may be used to receive various types of data and/or control signals (i.e., transmissions) over one or more communication links of a wireless communication system, such as one or more communication links of the wireless communications system 100 described with reference to FIG. 1.

In some examples, the BS transmitter 820 may include at least one RF transmitter, such as at least one RF transmitter operable to transmit information regarding a reserved resource pool. The BS transmitter 820 may be used to transmit various types of data and/or control signals (i.e., transmissions) over one or more communication links of a wireless communication system, such as one or more communication links of the wireless communications system 100 described with reference to FIG. 1.

In some examples, the resource pool manager 815 may reserve one or more resource pools for D2D discovery on a channel of an unlicensed LTE band. The resource pool manager 815 may identify a transmission bandwidth requirement for the channel. In some examples, the resource pool manager 815 may select a DRID size based on the transmission bandwidth requirements. In other examples, the apparatus 805 includes a D2D discovery manager similar to the D2D discovery manager 140.

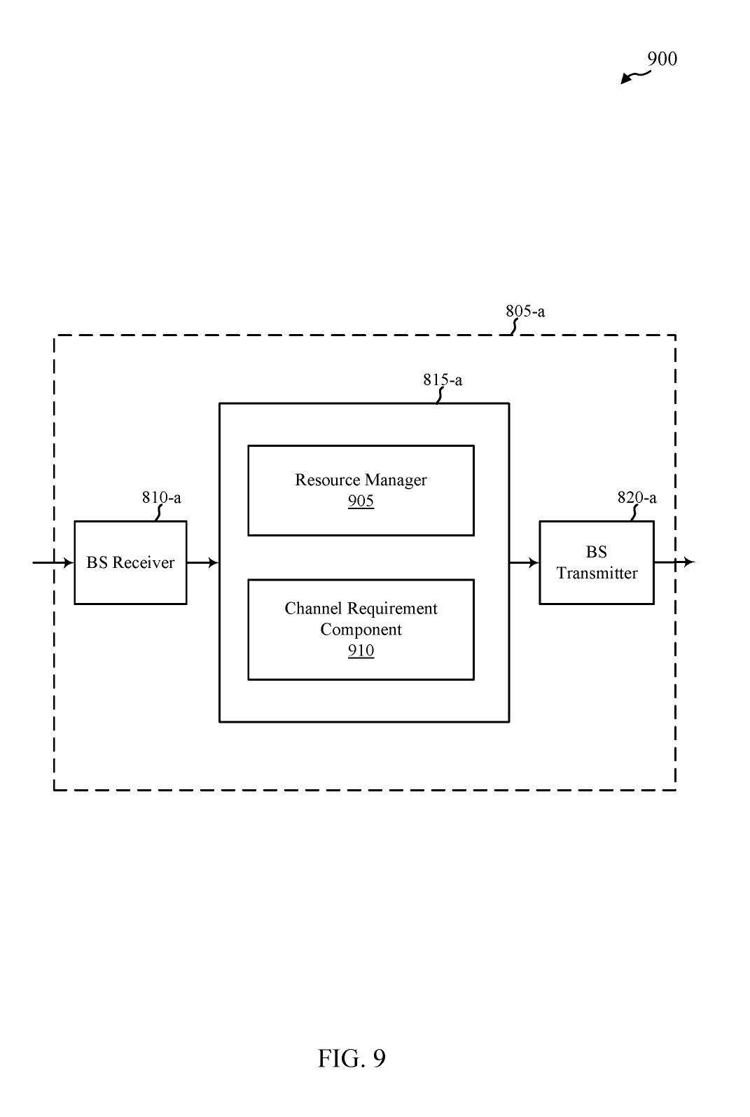

FIG. 9 shows a block diagram 900 of an apparatus 805-a for use in wireless communication, in accordance with various aspects of the present disclosure. In some examples, the apparatus 805-a may be an example of aspects of one or more of the base stations 105 described with reference to FIG. 1, and/or an example of aspects of the apparatus 805 described with reference to FIG. 8. In some examples, the apparatus 805-a may be part or include an LTE/LTE-A eNB and/or an LTE/LTE-A base station. The apparatus 805-a may also be a processor. The apparatus 805-a may include a BS receiver 810-a, a resource pool manager 815-a, and/or a BS transmitter 820-a. Each of these modules may be in communication with each other.

The components of the apparatus 805-a may, individually or collectively, be implemented using one or more ASICs adapted to perform some or all of the applicable functions in hardware. Alternatively, the functions may be performed by one or more other processing units (or cores), on one or more integrated circuits. In other examples, other types of integrated circuits may be used (e.g., Structured/Platform ASICs, FPGAs, and other Semi-Custom ICs), which may be programmed in any manner known in the art. The functions of each component may also be implemented, in whole or in part, with instructions embodied in a memory, formatted to be executed by one or more general or application-specific processors.

In some examples, the BS receiver 810-a may be an example of one or more aspects of the BS receiver 810 described with reference to FIG. 8. In some examples, the BS receiver 810-a may include at least one RF receiver, such as at least one RF receiver operable to receive discovery messages. The BS receiver 810-a may be used to receive various types of data and/or control signals (i.e., transmissions) over one or more communication links of a wireless communication system, such as one or more communication links of the wireless communications system 100 described with reference to FIG. 1.

In some examples, the BS transmitter 820-a may be an example of one or more aspects of the BS transmitter 820 described with reference to FIG. 8. In some examples, the BS transmitter 820-a may include at least one RF transmitter, such as at least one RF transmitter operable to transmit information regarding resource pools. The BS transmitter 820-a may be used to transmit various types of data and/or control signals (i.e., transmissions) over one or more communication links of a wireless communications system, such as one or more communication links of the wireless communications system 100 described with reference to FIG. 1.

The resource pool manager 815-a may include a resource manager 905 and a channel requirement component 910. The resource manager 905 may determine what resources may be reserved into resource pools. The channel requirement component 910 may determine requirements for transmitting on a channel, such as a channel of an unlicensed band.

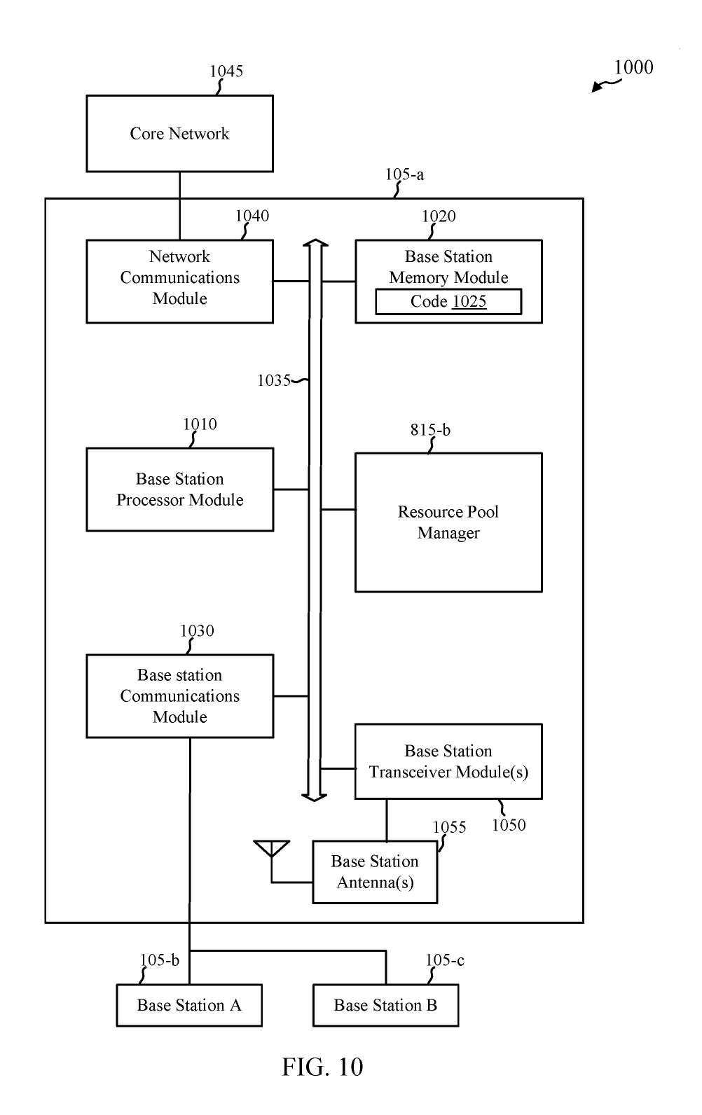

FIG. 10 shows a block diagram 1000 of a base station 105-a (e.g., a base station forming part or all of an eNB) for use in wireless communication, in accordance with various aspects of the present disclosure. In some examples, the base station 105-a may be an example of aspects of one or more of the base stations 105 described with reference to FIG. 1 and/or aspects of one or more of the apparatus 805 when configured as a base station, as described with reference to FIGS. 8 and/or 9. The base station 105-a may be configured to implement or facilitate at least some of the base station and/or apparatus features and functions described with reference to FIGS. 1, 8, and 9.

The base station 105-a may include a BS processor module 1010, a BS memory module 1020, at least one base station transceiver module (represented by BS transceiver module(s) 1050), at least one base station antenna (represented by base station antenna(s) 1055), and/or a resource pool manager 815-b. The base station 105-a may also include one or more of a BS communications module 1030 and/or a network communications module 1040. Each of these modules may be in communication with each other, directly or indirectly, over one or more buses 1035.

The BS memory module 1020 may include random access memory (RAM) and/or read-only memory (ROM). The BS memory module 1020 may store computer-readable, computer-executable software/firmware code 1025 containing instructions that are configured to, when executed, cause the BS processor module 1010 to perform various functions described herein related to wireless communication (e.g., D2D discovery resources for an unlicensed band, etc.). Alternatively, the computer-readable, computer-executable software/firmware code 1025 may not be directly executable by the BS processor module 1010 but be configured to cause the BS 105-a (e.g., when compiled and executed) to perform various of the functions described herein.

The BS processor module 1010 may include an intelligent hardware device, e.g., a central processing unit (CPU), a microcontroller, an ASIC, etc. The BS processor module 1010 may process information received through the BS transceiver module(s) 1050, the BS communications module 1030, and/or the network communications module 1040. The BS processor module 1010 may also process information to be sent to the transceiver module(s) 1050 for transmission through the antenna(s) 1055, to the BS communications module 1030, for transmission to one or more other base stations 105-b and 105-c, and/or to the network communications module 1040 for transmission to a core network 1045, which may be an example of one or more aspects of the core network 130 described with reference to FIG. 1. The BS processor module 1010 may handle, alone or in connection with the resource pool manager 815-b, various aspects of D2D discovery transmissions.

The base station transceiver module(s) 1050 may include a modem configured to modulate packets and provide the modulated packets to the base station antenna(s) 1055 for transmission, and to demodulate packets received from the base station antenna(s) 1055. The base station transceiver module(s) 1050 may, in some examples, be implemented as one or more base station transmitter modules and one or more separate base station receiver modules. The base station transceiver module(s) 1050 may support communications in a first radio frequency spectrum band and/or a second radio frequency spectrum band. The base station transceiver module(s) 1050 may be configured to communicate bi-directionally, via the antenna(s) 1055, with one or more UEs or apparatuses, such as one or more of the UEs 115 described with reference to FIGS. 1, 2, and 7. The base station 105-a may, for example, include multiple base station antennas 1055 (e.g., an antenna array). The base station 105-a may communicate with the core network 1045 through the network communications module 1040. The base station 105-a may also communicate with other base stations, such as the base stations 105-b and 105-c, using the BS communications module 1030.

The resource pool manager 815-b may be configured to perform and/or control some or all of the features and/or functions described with reference to FIGS. 1, 8, and 9 related to reserving resource pools and D2D discovery transmissions. The resource pool manager 815-b, or portions of the resource pool manager 815-b, may include a processor, and/or some or all of the functions of the resource pool manager 815-b may be performed by the BS processor module 1010 and/or in connection with the BS processor module 1010. In some examples, the resource pool manager 815-b may be an example of the resource pool manager 815 and/or 815-a described with reference to FIGS. 8 and/or 9.

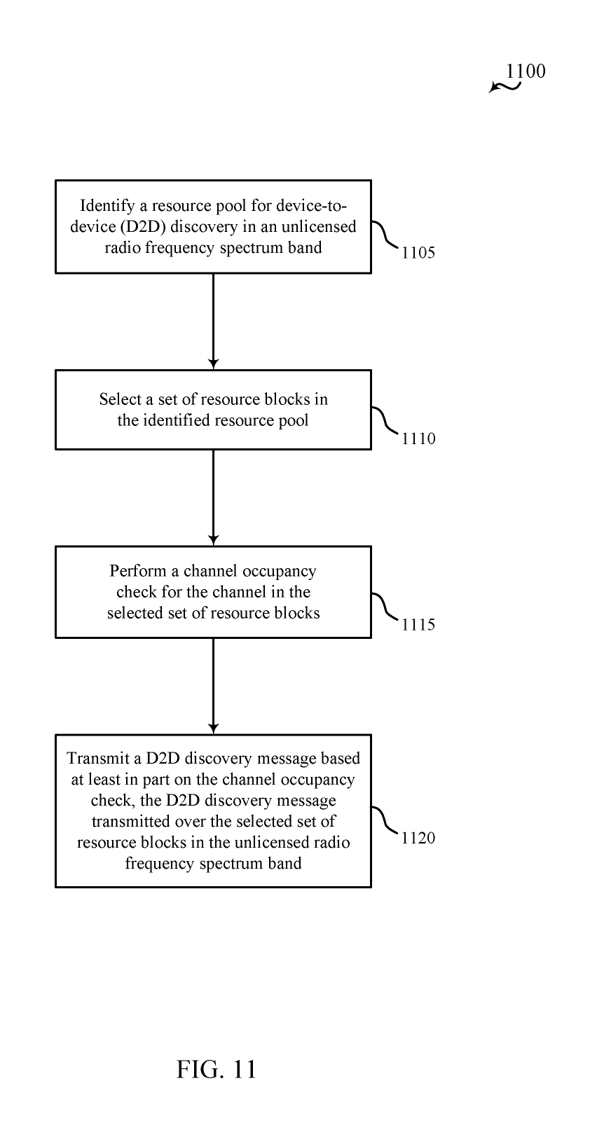

FIG. 11 is a flow chart illustrating an example of a method 1100 for wireless communication, in accordance with various aspects of the present disclosure. For clarity, the method 1100 is described below with reference to aspects of one or more of the UEs described with reference to FIGS. 1, 2, and 7, and/or aspects of one or more of the apparatuses described with reference to FIGS. 5 and 6. In some examples, a UE may execute one or more sets of codes to control the functional elements of the UE to perform the functions described below. Additionally or alternatively, the UE may perform one or more of the functions described below using special-purpose hardware.

At block 1105, the method 1100 may include identifying a resource pool for device-to-device (D2D) discovery in an unlicensed radio frequency spectrum band.

At block 1110, the method 1100 may include selecting a set of resource blocks in the identified resource pool. In some examples, the method 1100 may include identifying a transmission bandwidth requirement for the channel. Selecting the set of resource blocks in the resource pool may be based at least in part on the identified transmission bandwidth requirement. In some examples, the method 1100 further includes selecting one or more time-frequency resources from the identified resource pool, the time-frequency resources comprising at least the selected set of resource blocks. The selected time-frequency resources may cover different time periods.

At block 1115, the method 1100 may include performing a channel occupancy check for the channel in the selected set of resource blocks. In some examples, performing the channel occupancy check includes performing an LBT procedure for the channel in the selected set of resource blocks. In other examples, performing the channel occupancy check includes listening to the channel for a first time period to determine whether the channel is idle and waiting for a second time period after the first time period to transmit the D2D discovery message upon determining the channel is idle.

In some examples, the method 1100 includes selecting a first time period and a second time period to perform the channel occupancy check to be a duration corresponding to a duration of two OFDM symbols. In other examples, the duration may be different, such as 3 or more OFDM symbols or less than 2 OFDM symbols.

In another example, performing the channel occupancy check includes listening to the channel for a first time period to determine whether the channel is occupied for at least a portion of the selected first time-frequency resource. Upon determining the channel is occupied, the method 1100 includes listening to the channel for the first time period to determine whether the channel is idle for a second time-frequency resource, wherein the second time-frequency resource occurs after the first time-frequency resource.

At block 1120, the method 1100 may include transmitting a D2D discovery message based at least in part on the channel occupancy check, the D2D discovery message transmitted over the selected set of resource blocks in the unlicensed radio frequency spectrum band. In some examples, transmitting the D2D discovery message includes transmitting the D2D discovery message using a first time-frequency resource based on the channel occupancy check, the first time-frequency resource comprising at least a portion of the selected set of resource blocks.

In some examples, the method 1100 includes refraining from transmitting the D2D discovery message based at least in part on the channel occupancy check and listening for D2D discovery messages from other wireless devices during at least a portion of the selected set of resource blocks.

The operation(s) at blocks 1105, 1110, 1115, and 1120 may be performed using the D2D discovery manager 140 described with reference to FIGS. 1 and 5-8. Thus, the method 1100 may provide for wireless communication. It should be noted that the method 1100 is just one implementation and that the operations of the method 1100 may be rearranged or otherwise modified such that other implementations are possible.

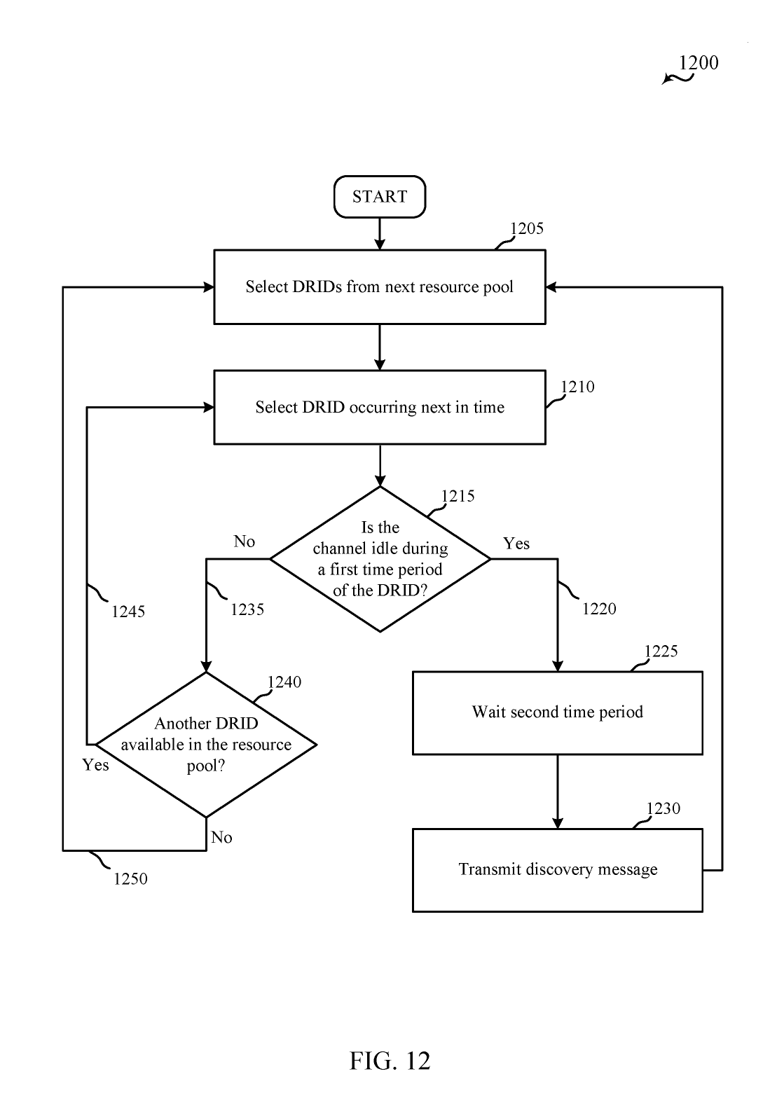

FIG. 12 is a flow chart illustrating an example of a method 1200 for wireless communication, in accordance with various aspects of the present disclosure. For clarity, the method 1200 is described below with reference to aspects of one or more of the UEs described with reference to FIGS. 1, 2, and 7, and/or aspects of one or more of the apparatuses described with reference to FIGS. 5 and 6. In some examples, a UE may execute one or more sets of codes to control the functional elements of the UE to perform the functions described below. Additionally or alternatively, the UE may perform one or more of the functions described below using special-purpose hardware. The method 1200 may be an example of performing a channel occupancy check before transmitting a discovery message.

The method 1200 includes selecting DRIDs from a next resource pool (1205). The next resource pool may be the next available resource pool on the network or may be another, later resource pool. The method 1200 may further include selecting a DRID that occurs next in time (1210). The next in time DRID may be a first occurring DRID of the selected DRIDs in the resource pool.

For the selected DRID, the method 1200 includes determining whether the channel is idle during a first time period of the DRID (1215). The first time period of the DRID may be the csTime period. If the channel is idle in the first time period, the method 1200 proceeds along path 1220 to wait for a second time period (1225). The second time period may be the RxTxTurnaround time. After the second time period, the method 1200 includes transmitting the discovery message (1230).

If the method 1200 determines that the channel is not idle during the first time period, the method 1200 proceeds along path 1235 to determine if there is another DRID available in the resource pool (1240). If there is another DRID available in the resource pool, the method 1200 proceeds along path 1245 to select the next in time DRID (1210) and proceeds as described. If there is not another DRID available in the resource pool, the method 1200 proceeds along path 1250 to select DRIDs from a next resource pool after that resource pool (1205).

The operation(s) at blocks 1205, 1210, 1215, 1225, 1230, and 1240 may be performed using the D2D discovery manager 140 described with reference to FIGS. 1 and 5-8. Thus, the method 1200 may provide for wireless communication. It should be noted that the method 1200 is just one implementation and that the operations of the method 1200 may be rearranged or otherwise modified such that other implementations are possible.

Techniques described herein may be used for various wireless communications systems such as CDMA, TDMA, FDMA, OFDMA, SC-FDMA, and other systems. The terms “system” and “network” are often used interchangeably. A CDMA system may implement a radio technology such as CDMA2000, Universal Terrestrial Radio Access (UTRA), etc. CDMA2000 covers IS-2000, IS-95, and IS-856 standards. IS-2000 Releases 0 and A are commonly referred to as CDMA2000 1×, 1×, etc. IS-856 (TIA-856) is commonly referred to as CDMA2000 1×EV-DO, High Rate Packet Data (HRPD), etc. UTRA includes Wideband CDMA (WCDMA) and other variants of CDMA. A TDMA system may implement a radio technology such as Global System for Mobile Communications (GSM). An OFDMA system may implement a radio technology such as Ultra Mobile Broadband (UMB), Evolved UTRA (E-UTRA), IEEE 802.11 (WiFi), IEEE 802.16 (WiMAX), IEEE 802.20, Flash-OFDM™, etc. UTRA and E-UTRA are part of Universal Mobile Telecommunication System (UMTS). 3GPP LTE and LTE-Advanced (LTE-A) are new releases of UMTS that use E-UTRA. UTRA, E-UTRA, UMTS, LTE, LTE-A, and GSM are described in documents from an organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies, including cellular (e.g., LTE) communications over an unlicensed and/or shared bandwidth. The description above, however, describes an LTE/LTE-A system for purposes of example, and LTE terminology is used in much of the description above, although the techniques are applicable beyond LTE/LTE-A applications.

The detailed description set forth above in connection with the appended drawings describes examples and does not represent the only examples that may be implemented or that are within the scope of the claims. The terms “example” and “exemplary,” when used in this description, mean “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and apparatuses are shown in block diagram form in order to avoid obscuring the concepts of the described examples.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a digital signal processor (DSP), an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. As used herein, including in the claims, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination. Also, as used herein, including in the claims, “or” as used in a list of items (for example, a list of items prefaced by a phrase such as “at least one of” or “one or more of”) indicates a disjunctive list such that, for example, a list of “at least one of A, B, or C” means A or B or C or AB or AC or BC or ABC (i.e., A and B and C).

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, EEPROM, flash memory, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not to be limited to the examples and designs described herein but is to be accorded the broadest scope consistent with the principles and novel features disclosed herein.

What is claimed is:

1. A method for wireless communication, comprising:
identifying a resource pool for device-to-device (D2D) discovery in an unlicensed radio frequency spectrum band;
selecting a set of resource blocks in the identified resource pool;
performing a channel occupancy check for a channel in the selected set of resource blocks; and
transmitting a D2D discovery message based at least in part on the channel occupancy check, the D2D discovery message transmitted over the selected set of resource blocks in the unlicensed radio frequency spectrum band.

2. The method of claim 1, further comprising:
identifying a transmission bandwidth requirement for the channel; and
selecting the set of resource blocks in the resource pool based at least in part on the identified transmission bandwidth requirement.

3. The method of claim 1, wherein performing the channel occupancy check comprises:
performing a listen-before-talk procedure for the channel in the selected set of resource blocks.

4. The method of claim 1, wherein performing the channel occupancy check comprises:
listening to the channel for a first time period to determine whether the channel is idle; and
waiting for a second time period after the first time period to transmit the D2D discovery message upon determining the channel is idle.

5. The method of claim 4, further comprising:
selecting the first time period and the second time period to perform the channel occupancy check to be a duration corresponding to a duration of two orthogonal frequency-division multiplexing (OFDM) symbols.

6. The method of claim 1, further comprising:
selecting one or more time-frequency resources from the identified resource pool, the time-frequency resources comprising at least the selected set of resource blocks.

7. The method of claim 6, wherein transmitting the D2D discovery message comprises:
transmitting the D2D discovery message using a first time-frequency resource based on the channel occupancy check, the first time-frequency resource comprising at least a portion of the selected set of resource blocks.

8. The method of claim 6, wherein performing the channel occupancy check comprises:
listening to the channel for a first time period to determine whether the channel is occupied for at least a portion of the selected first time-frequency resource; and
upon determining the channel is occupied, listening to the channel for the first time period to determine whether the channel is idle for a second time-frequency resource, wherein the second time-frequency resource occurs after the first time-frequency resource.

9. The method of claim 6, wherein the selected time-frequency resources cover different time periods.

10. The method of claim 1, further comprising:
refraining from transmitting the D2D discovery message based at least in part on the channel occupancy check; and
listening for D2D discovery messages from other wireless devices during at least a portion of the selected set of resource blocks.

11. An apparatus for wireless communication, comprising:
means for identifying a resource pool for device-to-device (D2D) discovery in an unlicensed radio frequency spectrum band;
means for selecting a set of resource blocks in the identified resource pool;
means for performing a channel occupancy check for a channel in the selected set of resource blocks; and
means for transmitting a D2D discovery message based at least in part on the channel occupancy check, the D2D discovery message transmitted over the selected set of resource blocks in the unlicensed radio frequency spectrum band.

12. The apparatus of claim 11, further comprising:
means for identifying a transmission bandwidth requirement for the channel; and
means for selecting the set of resource blocks in the resource pool based at least in part on the identified transmission bandwidth requirement.

13. The apparatus of claim 11, wherein means for performing the channel occupancy check comprises:
means for performing a listen-before-talk procedure for the channel in the selected set of resource blocks.

14. The apparatus of claim 11, wherein means for performing the channel occupancy check comprises:
means for listening to the channel for a first time period to determine whether the channel is idle; and
means for waiting for a second time period after the first time period to transmit the D2D discovery message upon determining the channel is idle.

15. The apparatus of claim 14, further comprising:
means for selecting the first time period and the second time period to perform the channel occupancy check to be a duration corresponding to a duration of two orthogonal frequency-division multiplexing (OFDM) symbols.

16. The apparatus of claim 11, further comprising:
means for selecting one or more time-frequency resources from the identified resource pool, the time-frequency resources comprising at least the selected set of resource blocks.

17. The apparatus of claim 16, wherein means for transmitting the D2D discovery message comprises:
means for transmitting the D2D discovery message using a first time-frequency resource based on the channel occupancy check, the first time-frequency resource comprising at least a portion of the selected set of resource blocks.

18. The apparatus of claim 16, wherein means for performing the channel occupancy check comprises:
means for listening to the channel for a first time period to determine whether the channel is occupied for at least a portion of the selected first time-frequency resource; and
means for upon determining the channel is occupied, listening to the channel for the first time period to determine whether the channel is idle for a second time-frequency resource, wherein the second time-frequency resource occurs after the first time-frequency resource.

19. The apparatus of claim 16, wherein the selected time-frequency resources cover different time periods.

20. The apparatus of claim 11, further comprising:
means for refraining from transmitting the D2D discovery message based at least in part on the channel occupancy check; and
means for listening for D2D discovery messages from other wireless devices during at least a portion of the selected set of resource blocks.

21. An apparatus for wireless communication, comprising:
a processor;
memory in electronic communication with the processor; and
instructions stored in the memory, the instructions being executable by the processor to:
identify a resource pool for device-to-device (D2D) discovery in an unlicensed radio frequency spectrum band;
select a set of resource blocks in the identified resource pool;
perform a channel occupancy check for a channel in the selected set of resource blocks; and
transmit a D2D discovery message based at least in part on the channel occupancy check, the D2D discovery message transmitted over the selected set of resource blocks in the unlicensed radio frequency spectrum band.

22. The apparatus of claim 21, wherein the instructions are further operable to cause the apparatus to:
identify a transmission bandwidth requirement for the channel; and
select the set of resource blocks in the resource pool based at least in part on the identified transmission bandwidth requirement.

23. The apparatus of claim 21, wherein the instructions are further operable to cause the apparatus to:
perform a listen-before-talk procedure for the channel in the selected set of resource blocks.

24. The apparatus of claim 21, wherein the instructions are further operable to cause the apparatus to:
listen to the channel for a first time period to determine whether the channel is idle; and
wait for a second time period after the first time period to transmit the D2D discovery message upon determining the channel is idle.

25. The apparatus of claim 21, wherein the instructions are further operable to cause the apparatus to:
select one or more time-frequency resources from the identified resource pool, the time-frequency resources comprising at least the selected set of resource blocks.

26. The apparatus of claim 25, wherein the instructions are further operable to cause the apparatus to:
transmit the D2D discovery message using a first time-frequency resource based on the channel occupancy check, the first time-frequency resource comprising at least a portion of the selected set of resource blocks.

27. The apparatus of claim 25, the instructions are further operable to cause the apparatus to:
listen to the channel for a first time period to determine whether the channel is occupied for at least a portion of the selected first time-frequency resource; and
upon determining the channel is occupied, listen to the channel for the first time period to determine whether the channel is idle for a second time-frequency resource, wherein the second time-frequency resource occurs after the first time-frequency resource.

28. The apparatus of claim 25, wherein the selected time-frequency resources cover different time periods.

29. The apparatus of claim 21, the instructions are further operable to cause the apparatus to:
refrain from transmitting the D2D discovery message based at least in part on the channel occupancy check; and
listen for D2D discovery messages from other wireless devices during at least a portion of the selected set of resource blocks.

30. A non-transitory computer-readable medium storing computer-executable code for wireless communication, the code executable by a processor to:
identify a resource pool for device-to-device (D2D) discovery in an unlicensed radio frequency spectrum band;
select a set of resource blocks in an identified resource pool;
perform a channel occupancy check for a channel in the selected set of resource blocks; and
transmit a D2D discovery message based at least in part on the channel occupancy check, the D2D discovery message transmitted over the selected set of resource blocks in the unlicensed radio frequency spectrum band.
